(19) United States
(12) Patent Application Publication
(10) Pub. No.: US 2012/0020049 A1
(43) Pub. Date: Jan. 26, 2012

(54) HOOK-TYPE ELECTRIC METER CAPABLE OF PROVIDING LIGHT SOURCE

(76) Inventor: Hsin-Chen KO, Taipei (TW)

(21) Appl. No.: 12/841,409

(22) Filed: Jul. 22, 2010

(51) Int. Cl. G01D 11/28

(52) U.S. Cl. 362/23

(57) ABSTRACT

A hook-type electric meter capable of providing a light source is provided, which includes a measurement body, having a display and a measurement shift manipulation key disposed thereon. A clip jaw is disposed at a top of the measurement body and a push handle for controlling opening/closing of the clip jaw is disposed at one side of the measurement body, such that the clip jaw forms a clip mouth for clipping a subject to be tested. The measurement body has a luminous source disposed at the top and facing the clip mouth of the clip jaw. The luminous source is connected to a power supply device in the measurement body and the push handle at one side of the measurement body respectively. Thus, when the push handle is pushed, the clip mouth of the clip jaw is driven to be opened and the luminous source is driven to emit light simultaneously, and the light rays from the luminous source are projected towards the direction of the clip mouth.

BACKGROUND OF THE UTILITY MODEL

1. Field of the Utility Model

The utility model relates to a hook-type electric meter capable of providing a light source, and more particularly to a hook-type electric meter capable of providing a lighting function while clipping a subject to be tested through a luminous source design, which has a simple structure and is conveniently operated.

2. Related Art

Currently, a multi-meter or a hook-type electric meter is generally used to measure the current and the voltage. The hook-type electric meter has an elongated shell, which is designed to be held with one hand. The main structure of the hook-type electric meter includes a hook disposed at a top end of the electric meter body to hook the wire to be measured. The hook is enabled to sense the values of the current and the voltage of the wire, which are displayed on a display panel on the electric meter body, such that the operator can know the state and data of the wire through the display panel.

The above design of the hook-type electric meter can achieve the measurement function. However, in practical use, most of the charged wires are hung overhead or in a narrow real space (for example, in an electrical wiring box). In a dark environment, the operator needs a flashlight for providing an additional lighting function, so as to hook the hook-type electric meter on a wire to be tested from numerous wires, which is rather inconvenient.

### SUMMARY OF THE UTILITY MODEL

Accordingly, the utility model is directed to a hook-type electric meter capable of providing a light source, which has a simple structure and is convenient for users to perform measurement.

In order to achieve the objectives described above, a hook-type electric meter capable of providing a light source is provided, which includes: a measurement body, having a display and a measurement shift manipulation key disposed thereon. A clip jaw is disposed at a top of the measurement body and a push handle for controlling opening/closing of the clip jaw is disposed at one side of the measurement body, such that the clip jaw forms a clip mouth for clipping a subject to be tested. The measurement body has a luminous source disposed at the top thereof and facing the clip mouth of the clip jaw. The luminous source is connected to a power supply device in the measurement body and the push handle at one side of the measurement body respectively. Thus, when the push handle is pushed, the clip mouth of the clip jaw is driven to be opened and the luminous source is driven to emit light simultaneously, and the light rays from the luminous source are projected towards the direction of the clip mouth.

When being implemented, the clip jaw has two clipping portions, and one end of the push handle is directly connected to one clipping portion, such that when the push handle is pushed, the two clipping portions are separated to form the clip mouth.

When being implemented, the other end of the push handle is connected between the power supply device in the measurement body and the luminous source, such that when the push handle is pushed, a circuit formed by the luminous source and the power supply device is turned on, and the luminous source emits light.

When being implemented, the luminous source is a light-emitting diode (LED).

In order to make the utility model more comprehensible, the specific content of the utility model and the effect achieved thereby are described in further detail through the preferred embodiments with reference to the drawings and drawing numbers.

### BRIEF DESCRIPTION OF THE DRAWINGS

FIG. 1 is a schematic three-dimensional outside view of a hook-type electric meter according to an embodiment of the utility model.

FIG. 2 is a top view of a hook-type electric meter according to an embodiment of the utility model.

FIG. 3 is a schematic view of a connection relation between a push handle and a luminous source and a power supply device according to an embodiment of the utility model.

FIG. 4 is a schematic view of a state after pushing a push portion according to an embodiment of the utility model.

FIG. 5 is a schematic view of a state after a hook-type electric meter clips a subject to be tested according to an embodiment of the utility model.

### DETAILED DESCRIPTION OF THE UTILITY MODEL

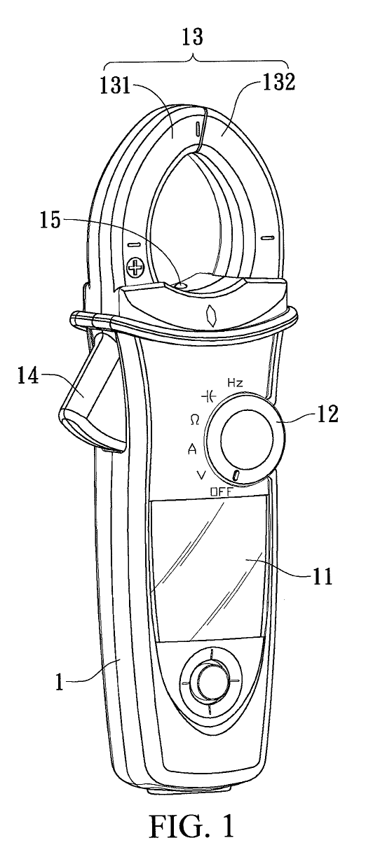

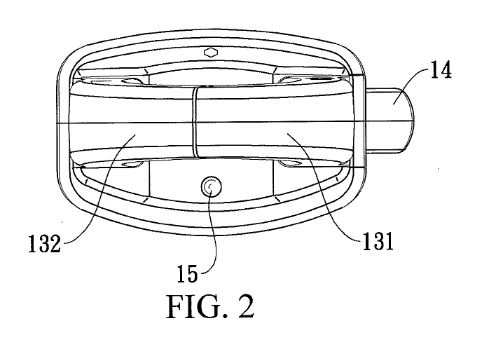

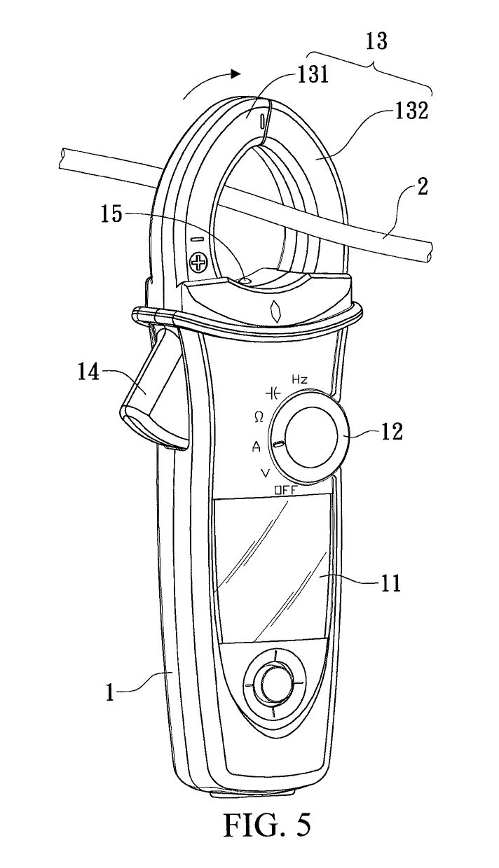

Referring to FIGS. 1 to 5, an embodiment of a hook-type electric meter capable of providing a light source according to the utility model is shown.

A hook-type electric meter capable of providing a light source in the utility model includes a measurement body 1. The measurement body 1 has a display 11 and a measurement shift manipulation key 12 disposed thereon. A clip jaw 13 is disposed at a top of the measurement body 1 and a push handle 14 for controlling opening/closing of the clip jaw 13 is disposed at one side of the measurement body 1. The clip jaw 13 has two clipping portions 131 and 132, and one end of the push handle 14 is directly connected to one clipping portion 131, such that when the push handle 14 is pushed, the two clipping portions 131 and 132 are separated to form a clip mouth 133, so as to clip a subject to be tested 2.

The measurement body 1 has a luminous source 15 disposed at the top thereof and facing the clip mouth 133 of the clip jaw 13. The luminous source 15 is an LED. The luminous source 15 is connected to a power supply device 16 in the measurement body 1 and the push handle 14 at one side of the measurement body 1 respectively. Actually, the other end of the push handle 14 is connected between the power supply device 16 in the measurement body 1 and the luminous source 15, such that when the push handle 14 is pushed, a circuit formed by the luminous source 15 and the power supply device 16 is turned on, and the luminous source 15 emits light, and light rays from the luminous source 15 are projected towards the direction of the clip mouth 133.

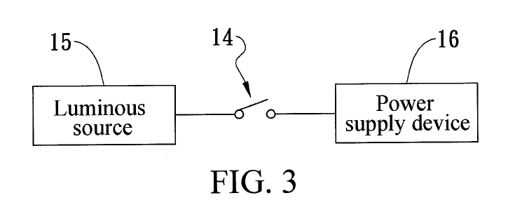

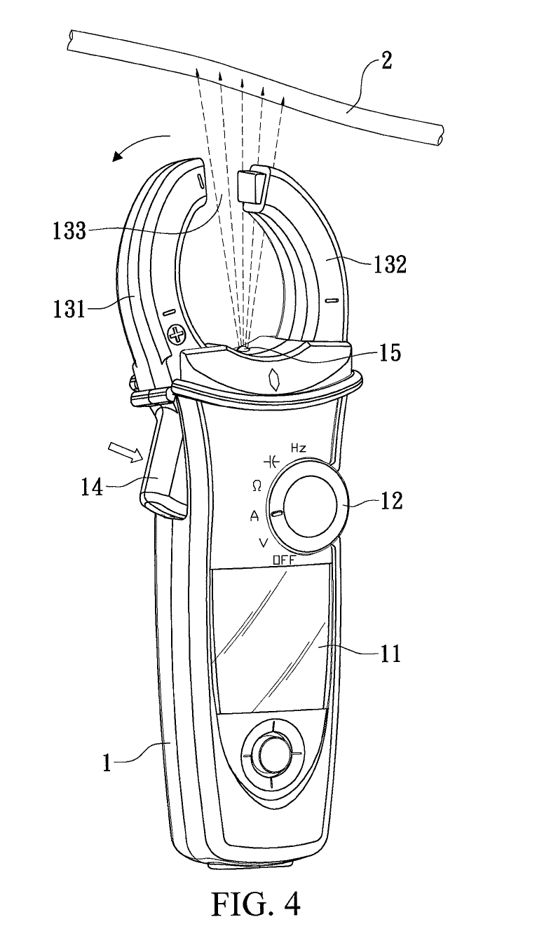

Therefore, during the implementation, referring to FIGS. 3 to 4, when the push handle 14 is not pushed before the test, the two clipping portions 131 and 132 of the clip jaw 13 are in a clipping state, and the circuit formed by the luminous source 15 and the power supply device 16 is in an open circuit state, so that the luminous source 15 does not emit light. When the user gets ready to perform the measurement and pushes the push handle 14, one end of the push handle 14 is directly connected to the clipping portion 131, such that the two clipping portions 131 and 132 are separated to form the clip mouth 133. Meanwhile, when the push handle 14 is pushed, the circuit formed by the luminous source 15 and the power supply device 16 is driven to be turned on, such that the luminous source 15 emits light, and the emitted light rays are projected towards the direction of the clip mouth 133.

Accordingly, the user can clearly determine a position of the subject to be tested 2 in a dark environment through the light rays from the luminous source 15, accurately clip the subject to be tested 2 (such as, a wire) into the clip mouth 133, and perform the measurement operation after the push handle 14 is released. Meanwhile, the circuit formed by the luminous source 15 and the power supply device 16 turns to an open circuit state, once the push handle 14 is released from the pushed state, and the luminous source 15 stops emitting light. Therefore, through the design of the push handle 14 similar to the design of a switch, the utility model controls opening/closing of the clip mouth 133 and further controls whether to drive the luminous source 15, such that when the user pushes the push handle 14, the required lighting effect is obtained immediately, so that the subject to be tested 2 is clipped rapidly and accurately.

The specific embodiments and the technical solutions used in the utility model are such described, many variations and modifications can be derived according to the disclosure and teaching of the specification. If the effect generated by the equivalent changes made according to the ideas of the utility model is still within the real spirit of the specification and the drawings, the equivalent changes shall be regarded as being in the technical scope of the utility model.

To sum up, according to the above disclosed content, the utility model may surely achieve the anticipated objects of the utility model, in which a hook-type electric meter capable of providing a light source having a simple structure and being convenient for user to perform measurement is provided, which has the value of industrial applicability and practical applicability definitely, so the application is filed for a utility model patent according to the law.

What is claimed is:

1. A hook-type electric meter capable of providing a light source, comprising:
a measurement body, having a display and a measurement shift manipulation key disposed thereon, wherein a clip jaw is disposed on a top of the measurement body and a push handle for controlling opening/closing of the clip jaw is disposed at one side of the measurement body, such that the clip jaw forms a clip mouth for clipping a subject to be tested; and
the measurement body has a luminous source disposed at the top thereof and facing the clip mouth of the clip jaw, the luminous source is connected to a power supply device in the measurement body and the push handle at one side of the measurement body respectively, such that the clip mouth of the clip jaw is driven to be opened and the luminous source is driven to emit light simultaneously when the push handle is pushed, and light rays from the luminous source are projected towards a direction of the clip mouth.

2. The hook-type electric meter capable of providing a light source according to claim 1, wherein the clip jaw has two clipping portions, and one end of the push handle is directly connected to one clipping portion, such that when the push handle is pushed, the two clipping portions are separated to form the clip mouth.

3. The hook-type electric meter capable of providing a light source according to claim 1, wherein the other end of the push handle is connected between the power supply device in the measurement body and the luminous source, such that a circuit formed by the luminous source and the power supply device is turned on when the push handle is pushed, and the luminous source emits light.

4. The hook-type electric meter capable of providing a light source according to claim 2, wherein the other end of the push handle is connected between the power supply device in the measurement body and the luminous source, such that a circuit formed by the luminous source and the power supply device is turned on when the push handle is pushed, and the luminous source emits light.

5. The hook-type electric meter capable of providing a light source according to claim 1, wherein the luminous source is a light-emitting diode (LED).
